(19) United States
(12) Patent Application Publication
(10) Pub. No.: US 2019/0013147 A1
(43) Pub. Date: Jan. 10, 2019

(54) NETWORK TRANSFORMER

(71) Applicant: APPS (SHENZHEN) ELECTRONICS LIMITED, Shenzhen City (Guangdong) (CN)

(72) Inventor: Yang HE, Shenzen City (Guangdong) (CN)

(21) Appl. No.: 15/737,651

(22) PCT Filed: Nov. 7, 2016
(86) PCT No.: PCT/CN2016/104938

§ 371 Date: Dec. 18, 2017

(30) Foreign Application Priority Data
Oct. 13, 2016 (CN) 201621121487.X

(51) Int. Cl. H01F 41/02; H01F 27/06; H01F 27/28; H01F 27/02; H01F 27/24; H01F 30/06

(52) U.S. Cl. CPC H01F 41/02; H01F 27/06; H01F 30/06; H01F 27/02; H01F 27/24; H01F 27/28

(57) ABSTRACT

Disclosed is a network transformer. The network transformer includes a base and an upper cover, with the base and the upper cover being engaged with each other to form a receiving cavity. The receiving cavity is provided therein with a magnetic core coil. In manufacturing the network transformer provided in embodiments of the present application, a thread head and a thread tail of the magnetic core coil are welded with the base by an automatic spot welder, and then the upper cover is fixedly connected to the base, so that the manufacturing process is simplified, which ensures the rate of qualified products and improves the using effect.

### TECHNICAL FIELD

The present application relates to the technical field of magnetic device, and particularly to a network transformer.

### BACKGROUND ART

A transformer is an apparatus which changes an alternating current (AC) voltage according to the principle of electromagnetic induction, and is mainly constituted by a coil and a magnetic core. In electrical equipment and wireless circuits, the transformer is commonly used for stepping up or stepping down a voltage, matching impedance, safety isolation or the like. In an electric generator, an electric potential can be induced in a coil, no matter whether the coil moves through a magnetic field or the magnetic field moves through a fixed coil. In both cases above, the value of magnetic flux remains constant, but the magnetic flux of the intersecting chain of the coil may be changed, which is the principle of mutual induction. A transformer is a device that transforms a voltage, a current and impedance by utilizing electromagnetic mutual induction. The transformer mainly has the following functions: voltage transformation, current transformation, impedance transformation, isolation, voltage stabilization (saturated magnetic transformer) and so on.

A network transformer is connected between an Ethernet transceiver chip and an interface of terminal equipment, and functions as signal transmission, impedance matching, waveform restoration, signal clutter suppression and high voltage isolation. The network transformers are mainly applied to network equipment such as routers and computers.

In the prior art, internal terminals and external terminals of a network transformer are designed to be on a rubber shell, which causes that a thread head and a thread tail of a magnetic core coil have to be manually wound onto the internal terminals within the rubber shell, and then the thread head and the thread tail are fixedly welded with the internal terminals through a high temperature tin-dipping operation. However, such operation is inefficient, and there is a risk that an operator would be burned in the high temperature tin-dipping operation. Moreover, the magnetic core coil of the product is made by winding enameled wires, and the high temperature tin-dipping operation would easily destroy an enamel leather of the magnetic core coil, which causes the product to have a hidden danger of a poor withstand voltage. Moreover, if scaling powders used in the high temperature tin-dipping operation are not cleaned thoroughly, the terminals would be easily polluted, and poor board feeding would occur at the client. In addition, in the traditional technology, the external terminals on the rubber shell is very thin due to the requirements of the product, and thus they would be easily deflected and deformed during the manufacture, packaging and transport of the product and during the use by the client, which causes an extreme high defect rate. Such defection would result in product failure during the use by the client, but it is usually time and labor consuming in handling such defection, and it is impossible to completely preclude the outflow of defective products and such defection may also be caused during transportation. The manufacturing flow of the product at the present stage is complex, and it generally includes steps as follows: winding a magnetic core coil on an internal terminal→performing a high temperature tin-dipping operation on the internal terminal→cleaning→drying→testing the semi-finished product→glue dispensing→drying→printing→performing the high temperature tin-dipping operation on an external terminal→cleaning→drying→finishing the flatness of the external terminal. As can be seen, the production cycle is relatively long and the defection rate of the production is always high, which significantly wastes the resources.

### SUMMARY OF THE INVENTION

In view of this, an object of embodiments of the present application is to provide a network transformer. The network transformer can improve the manufacturing efficiency thereof and the yield rate of the production hereby.

A network transformer includes a base and an upper cover. The base and the upper cover are engaged with each other to form a receiving cavity. The receiving cavity is provided therein with a magnetic core coil.

Furthermore, the magnetic core coil is welded on the base. Here, the welding may be realized by an automatic spot welder.

Furthermore, copper wires of the magnetic core coil are directly welded with a pad of the base, or be welded by using tin, with the pad of the base.

Furthermore, no covering is provided on a welding point with the welding point used for welding. Alternatively, a covering may be provided on the welding point with the welding point used for welding, e.g. a primer, a UV glue, a resin layer or the like.

Furthermore, the magnetic core coil is in number of at least one.

Furthermore, the base is provided with a locating hole, and the upper cover is provided with a locating column. The locating column is inserted into the locating hole, so that the upper cover can be covered on the base.

Furthermore, the locating column is in number of three.

Furthermore, the locating hole is in number of three.

Furthermore, the base is provided with a mounting groove for mounting the magnetic core coil.

Furthermore, the mounting groove is in number of at least one.

Furthermore, the base is in a shape of a flat plate.

Furthermore, an outer edge of the base is provided with a groove.

In manufacturing the network transformer provided in embodiments of the present application, a thread head and a thread tail of the magnetic core coil are welded with the base by an automatic spot welder, and then the upper cover is fixedly connected onto the base, so that the manufacturing process is simplified, which ensures the field rate of the production and improves the usage effect. In addition, a covering is provided on the welding point with the welding point used for welding, to protect the welding point, thereby further ensuring the yield rate of the products and further improving the usage effect.

In order to make the above-mentioned objects, features and advantages of the present application more obvious and easy to understand, preferred embodiments will be specifically enumerated below and described in detail with reference to the accompanying drawings as follows.

### BRIEF DESCRIPTION OF THE DRAWING

In order to more clearly illustrate the technical solutions of the embodiments of the present application, brief description will be made below for the drawing to be used in the embodiments. It shall be understood that the following drawing merely shows some of the embodiments of the present application, and thus shall not be construed as limiting to the scope. For a person skilled in the art, other relevant drawings could be obtained according to the drawing without any inventive efforts.

FIG. 1 shows a structural drawing of a network transformer provided in an embodiment of the present application.

### REFERENCE SIGNS OF MAIN ELEMENTS

100 network transformer
20 base
21 locating hole
22 groove
40 upper cover
41 locating column
60 magnetic core coil.

### DETAILED DESCRIPTION OF THE EMBODIMENTS

In order to facilitate the understanding of the present application, a network transformer will be more comprehensively depicted below with reference to relevant drawing. A preferred embodiment of the network transformer is shown in the drawing. However, the network transformer may be implemented in various different forms, and is not limited to the embodiments depicted herein. On the contrary, the object of providing these embodiments is to make the disclosure of the network transformer more thorough and comprehensive.

It shall be understood in the depiction of the present application that, orientation or position relationships indicated by terms, such as “longitudinal”, “transverse”, “upper”, “lower”, “front”, “rear”, “left”, “right”, “vertical”, “horizontal”, “top”, “bottom”, “inner”, and “outer”, are orientation or position relationships shown based on the drawing, merely for facilitating the depiction of the present application and for simplifying the depiction, rather than indicating or implying that the specified apparatus or element must have a specific orientation, or be constructed and operated in a certain orientation, and therefore cannot be construed as limiting to the present application.

In the depiction of the present description, depiction referring to terms such as “one embodiment”, “some embodiments”, “an example”, “specific example” or “some examples” indicates that specific features, structures, materials or characteristics depicted in combination with the embodiment or example are included in at least one embodiment or example of the present application. In the present description, schematic expressions of the above-mentioned terms do not necessarily indicate same embodiment or example. Moreover, the depicted specific features, structures, materials or characteristics can be combined in a suitable way in any one or more embodiments or examples.

It shall be noted in the depiction of the present application that, unless otherwise specified and defined, terms such as “mount”, “connect”, and “connection” shall be construed in a broad sense. For example, it may be either a mechanical connection or an electrical connection, or may also be an inner communication between two elements, or it may be a direct connection or an indirect connection via an intermediate. For a person skilled in the art, the specific meanings of the above-mentioned terms could be understood in accordance with the specific circumstances.

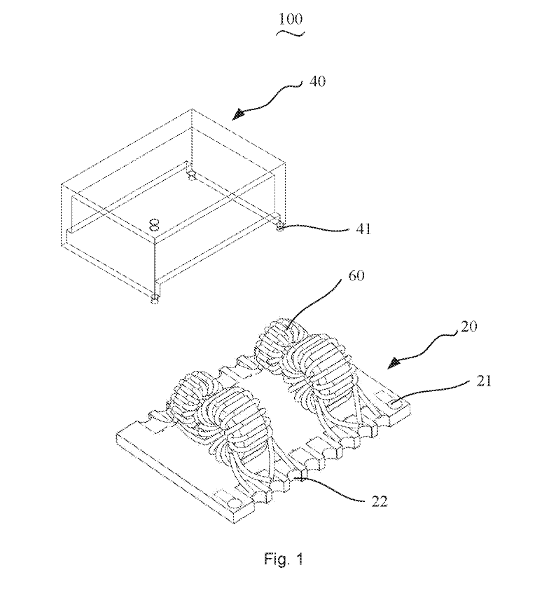

Referring to FIG. 1, a network transformer 100 provided in an embodiment of the present application includes a base 20 and an upper cover 40. The base 20 and the upper cover 40 are engaged with each other to form a receiving cavity, and the receiving cavity is provided therein with a magnetic core coil 60.

In the above embodiment, in manufacturing the network transformer 100, a thread head and a thread tail of the magnetic core coil 60 is welded with the base 20 by an automatic spot welder, and then the upper cover 40 is fixedly connected on the base 20, so that the manufacturing process is simplified, which ensures the field rate of the products and improves the usage effect.

The magnetic core coil 60 may include a magnetic ring and a coil. The coil is wound around the magnetic ring. An end of the wound coil is configured to be connected to an external circuit, and of course, the connection may also be realized by providing a pin. The function of the magnetic core coil 60 is to produce electromagnetic induction. It can be understood that the magnetic core coil 60 includes a primary magnetic core coil 60 and a secondary magnetic core coil 60. The primary magnetic core coil 60 is configured to produce a varying magnetic field when being powered, and the secondary magnetic core coil 60 is configured to produce a current in the magnetic field. For convenience, the magnetic core coil 60 constituted by the primary magnetic core coil 60 and the secondary magnetic core coil 60 is deemed as a group of magnetic core coils. That is to say, one magnetic core coil 60 is also referred to as a group of magnetic core coils 60.

The magnetic core may be an H-shaped magnetic core, an I-shaped magnetic core, a toroidal magnetic core, a C-shaped magnetic core or a jug-shaped magnetic core. As to the material of the magnetic core, materials well known in the art, such as iron core of silicon steel sheet, permalloy or amorphous and nanocrystalline soft magnetic alloy, may be adopted. Here, the silicon steel sheet is a kind of alloy, where an iron-silicon alloy formed by adding a small amount of silicon (generally, with a content less than 4.5%) into pure iron is called as silicon steel. A highest saturate magnetic induction density value of this type of iron cores is 20000 Gs. As such iron core has advantages such as relatively good magnetic and electric property, easy mass production, low price and small influence caused by a mechanical stress, the iron core are best suited for low frequency and high power applications. Cold-rolled silicon steel sheet DG3, cold-rolled non-oriented electrical steel strip DW, cold-rolled oriented electrical steel strip DQ are commonly used. The permalloy refers to an iron-nickel alloy with the content of nickel ranging from 30% to 90%. The permalloy is a kind of soft magnetic alloy, which is widely used. Magnetic properties can be effectively controlled via appropriate processes, for example, an initial permeability exceeding 105, a maximum permeability exceeding 106, a coercive force as low as 2‰Oersted and a rectangle coefficient close to 1 or close to 0 could be obtained. A permalloy with a face-centered cubic crystal structure has a very excellent plasticity, and it may be processed into an ultrathin strip of 1 μm and various use patterns. The commonly used alloys include 1J50, 1J79, 1J85 and so on. saturation magnetic induction density of 1J50 is slightly lower than that of the silicon steel, but the permeability of 1J50 is higher than that of the silicon steel by dozens of times, and an iron loss of 1J50 is lower than that of the silicon steel by 2 to 3 times. The silicon steel and permalloy soft magnetic material are both crystalline materials, specifically, atoms are regularly arranged in a three-dimensional space to form a periodic lattice structure; however, there are defects such as crystal grain, crystal boundary, dislocation, interstitial atom and magneto-crystalline anisotropy, which are disadvantageous to soft magnetic properties. In terms of the magnetic physics, an amorphous structure, which has irregularly atom arrangement and has no periodicity, no crystal grain or no crystal boundary, is very ideal for obtaining excellent soft magnetic properties. Amorphous metals and alloys are shaped at one time from molten steel to finished thin strip by utilizing an ultra-quick cooling solidification technology with a cooling rate of about one million degree per second. Due to the ultra-quick cooling solidification, there is no enough time for atoms to be orderly arranged and crystallized at the solidification of the alloy, and thus the resultant solid alloy is present as a long-range disordered structure, without the crystal particles or crystal boundaries as that of crystalline alloy, and thus is called as amorphous alloy. Such amorphous alloy has excellent magnetism, corrosion resistance, wear resistance, high strength, high hardness, high tenacity, high electric resistivity and electromechanical coupling properties or the like.

The magnetic core coil 60 may be in number of one or two, and of course, the magnetic core coil 60 may also be in number of more than two. The two magnetic core coils 60 may be arranged on the base 20 side by side.

There are many implementations for arranging the magnetic core coil 60 in the receiving cavity. In a first preferred implementation, the magnetic core coil 60 may be welded on the base 20. Here, the welding may be specifically realized as follows: the thread head and the thread tail of the wound coil of the magnetic core coil 60 are welded with the base 20 by the automatic spot welder. Specifically, copper wires of the magnetic core coil 60 may be directly welded with pads of the base 20. Alternatively, the copper wires of the magnetic core coil 60 may be welded, by using tin, with the pad of the base 20. Here, no covering is provided on a welding point (not shown in the figure) with the welding point used for welding. Alternatively, a covering may be provided on the welding point (not shown in the figure) with the welding point used for welding.

In a second implementation, the magnetic core coil 60 may be bonded onto the base 20 by means of a potting adhesive or the like. Here, the potting adhesive is liquid, has fluidity before curing, and can function, after complete curing, as water and moisture proofing, dust prevention, insulation, heat conduction, sealing, corrosion protection, temperature resistance and shock proofing. As to the potting adhesive, epoxy resin potting adhesive, organic silicon rubber potting adhesive, polyurethane potting adhesive, UV potting adhesive and hot-melt potting adhesive may be adopted. The epoxy resin potting adhesive has a small viscosity and strong infiltration, and thus can be filled between elements and wires; in a potting and curing process, components of powder such as a filler are hardly sedimentated, and no stratification occurs; the epoxy resin potting adhesive has a low curing exothermic peak and small curing shrinkage; the cured product of the epoxy resin potting adhesive has excellent electrical properties and mechanical properties, excellent heat resistance, and the epoxy resin potting adhesive has good cohesiveness to multiple materials, and small water absorption and small coefficient of linear expansion; and the epoxy resin potting adhesive also has properties such as flame retardancy, weathering resistance, heat conduction, and resistance to alternation between a high temperature and a low temperature. The organic silicon rubber potting adhesive provides the following advantages: 1. such adhesive presents a semi-solidified state after curing, and it has excellent cohesiveness and sealing property for many base materials, and it has extremely excellent resistance to cold and hot alternation; 2. gel would not be rapidly generated after two components are mixed, and thus there is a long operable duration, but once being heated, the two components would be rapidly cured, and the curing time can be freely controlled; 3. no by-product is produced in the curing process, and no shrinkage occurs; 4. such adhesive has excellent electrical insulation property and resistance to high and low temperatures (−50° C.-200° C.); and 5. the gel can automatically heal itself after cracking caused by an external force, which also provides functions of water and moisture proofing and thus does not affect the usage effect. The polyurethane potting adhesive is also called as PU potting adhesive. Polyurethane elastic potting material overcomes the drawback of embrittlement of the commonly used epoxy resin and drawbacks of low strength and poor cohesiveness of the organic silicon resin, and has excellent water resistance, heat resistance, cold resistance, anti-ultraviolet performance, acid and alkali resistance, resistance to high and low temperature shock, moisture proofing, environmental protection and high performance cost ratio. The UV light curing potting adhesive refers to a potting adhesive that can be cured under UV-irradiation. The hot-melt potting adhesive refers to a potting adhesive that is melt when being heated so as to remove the adhesion effect, e.g. EVA hot-melt adhesive.

In a third implementation, for example, a clamper (not shown in the figure) may be provided on the base 20 to clamp the magnetic core coil 60 on the base 20, so that the magnetic core coil 60 may be detachably mounted on the base 20.

Now, an implementation of the clamper is given. The clamper includes a clamping body and a connecting part. The clamping body is composed of a first clamp and a second clamp that are both arc-shaped. One end of the first clamp and one end of the second clamp are hinged with each other, while the other end of the first clamp and the other end of the second clamp each are provided as a connecting end. The connecting end of the first clamp is hinged with one end of a connecting rod, while the other end of the connecting rod can be freely rotated to the connecting end of the second clamp. The connecting end of the second clamp is provided with a connecting hole, and a pin hole is provided on the connecting rod at a position other than the non-free end, with the pin hole being configured for insertion of a pin. The shape of the connecting hole is substantially the same as the shape of the pin hole, such that the pin can simultaneously run through the pin hole and the connecting hole. A lock cover is connected with a free end of the connecting rod, and the lock cover is provided with a locking groove, with the shape of the locking groove matching the shape of the second clamp. Moreover, the lock cover is resilient, and the periphery of the locking groove can be resiliently expanded or contracted, such that the second clamp can be pressed into the locking groove.

If the first clamp and the second clamp would be assembled together, the connecting rod is pulled to the connecting end of the second clamp, such that the pin hole is aligned with the connecting hole, and then the pin can be inserted. Subsequently, the lock cover is pressed until the lock cover fits against the second clamp and the second clamp is clamped in the lock cover. In this way, the first clamp and the second clamp can be better locked. If there is a need to detach the first clamp from the second clamp, the second clamp has to be pulled out of the locking groove, the pin is drawn out of the pin hole, and the connecting rod is pulled to be disengaged from the connecting end of the second clamp.

A second implementation of the clamper is as follows. The clamper includes a clamping body and a connecting part. The clamping body is resilient, that is to say, the clamping body may be expanded or contracted due to the resiliency. The shape of the clamping body is substantially the same as that of a vent chimney, that is, in a quasi-circular shape. Preferably, the clamping body is of a shape with a radian greater than that of a semi-circle. Both ends of the clamping body are respectively provided with a first connecting end and a second connecting end. The first connecting end is hinged with a connecting frame (which may be for example rectangular). One end of the connecting frame is fixed on the first connecting end via a hinged shaft, while the other end can be freely rotated, and the free end of the connecting frame can accommodate the second connecting end. The free end of the connecting frame is hinged with a lock cover. The lock cover is in a structure similar to that of the clamper described above in the first implementation. However, the difference lies in that the shape of the locking groove of this lock cover matches the shape of the connecting frame, so as to enable the connecting frame to be clamped into the locking groove. If an object needs to be clamped, the connecting frame is pulled to the position of the second connecting end, so that the connecting frame accommodates the second connecting end. The lock cover is pressed downwards, so that the lock cover is clamped in the surface of the clamping body. In this case, because of the resiliency of the clamping body, the lock cover pulls the connecting frame connected to the second connecting end. If the object needs to be released, it may be achieved only by disengaging the lock cover from the clamping body. In this way, the connecting frame would automatically release the second connecting end due to the resiliency of the clamping body.

A third implementation of the clamper is as follows. The clamper includes a clamping body and a connecting part. The clamping body is composed of a first clamp and a second clamp that are both arc-shaped. One end of the first clamp and one end of the second clamp are hinged with each other, while the other end of the first clamp and the other end of the second clamp each are provided as a connecting end. The connecting end of the first clamp is hinged with one end of a connecting rod, while the other end of the connecting rod can be freely rotated to the connecting end of the second clamp. An outer surface of the connecting rod is provided with screw threads, and a screw cap is further provided, with the screw cap matching the screw thread. The connecting end of the second clamp is provided with an opening, such that the connecting rod may be rotated to and then engaged with the connecting end of the second clamp.

If the first clamp and the second clamp would be assembled together, the connecting rod is pulled to the connecting end of the second clamp, and the screw cap is screwed, such that the screw cap abuts against the connecting end of the second clamp. If there is a need to detach the first clamp from the second clamp, it may be achieved by only backing out the screw cap.

In an embodiment in which the magnetic core coil 60 is welded on the base 20, a mounting groove may be provided, such that the magnetic core coil 60 may be placed in the mounting groove. The mounting groove may be circular, square or the like.

The above-mentioned term “groove” shall be construed in accordance with the common sense in the mechanical field, that is to say, the groove may be called as a “hole” sometimes. For a case under a circle or quasi-circle (e.g. ellipse) shape, the groove indicates a spatial entity that is closed in all diametrical directions (called as “radial direction” for short, omnidirectional) and is open in at least one direction perpendicular to the radial direction (that is an axial direction, and there are two axial directions). Here, a spatial entity that is open in both axial directions is called as a through groove (hole); while a spatial entity that is open only in one axial direction is called as a semi-through groove (hole). For a case under a cuboid shape, the groove indicates a spatial entity which, among length measurements in three dimensions (represented by length, width and height, which can be respectively represented by X axis, Y axis and Z axis of an orthogonal coordinate system in mathematics), is closed in directions decided by two dimensions (assuming X axis and Y axis), and is open in at least one of two directions decided by the remaining dimension (i.e. Z axis). Here, a spatial entity that is open in both directions decided by Z-axis is called as a through groove (hole); and a spatial entity that is open in only one of the directions decided by Z-axis is called as a semi-through groove (hole). As to the above definitions for the groove, the grooves, as defined in the two different situations based on the circle or quasi-circle shape and the cuboid shape, are respectively called as an arc-shaped groove (hole) and a cuboid groove (hole).

The mounting groove mentioned above and the magnetic core coil 60 are the same in terms of number. In case the magnetic core coil 60 is in number of two, the mounting groove is also in number of two.

The base 20 mentioned above may be in a shape of a flat plate. Of course, the base 20 may also be implemented in other ways, which will be described in detail in following embodiments in which the base 20 and the upper cover 40 are engaged with each other.

A structure in which the base 20 and the upper cover 40 are engaged with each other may be implemented in various ways. In a first implementation, the base 20 is provided with a locating hole 21, and the upper cover 40 is provided with a locating column 41. The locating column 41 can be inserted into the locating hole 21.

The locating hole 21 may be in number of three, or more than three. Correspondingly, the locating column 41 may also be in number of three or more than three. The locating holes 21 may be located at three corners of the base 20. The three locating columns 41 may also be arranged at three corners of the upper cover 40.

In a second implementation, the base 20 includes a bottom wall, two side walls and two end walls, with the bottom wall, the two side walls and the two end walls forming the cavity described above. Each of the end walls is provided with a clamping groove, and the end wall includes a wall body and a clamping bulge. Both the clamping bulge and the clamping groove are arranged on the top of the wall body, and the clamping groove runs through the wall body and the clamping bulge. Herein, an upper end face of the clamping bulge is a smooth slope, and a lower end portion of the clamping bulge is of a rectangular structure. The bottom of the clamping groove is lower than the top of the side wall.

In the second embodiment, the upper cover includes a main plate and two engaging walls cooperating with the end walls. The two engaging walls are respectively arranged at both ends of the main plate. Herein, each of the engaging walls includes a wall plate portion and a projecting portion matching the clamping groove. Both the wall plate portion and the projecting portion are fixedly arranged on an end of the main plate. Moreover, the wall plate portion is provided with an opening and the projecting portion is located in the opening, such that an engaging opening is formed between the wall plate portion and the projecting portion, with the engaging opening matching the clamping bulge. The clamping grooves on the two end walls are respectively denoted as a first clamping groove and a second clamping groove, the projecting portion matching the first clamping groove is denoted as a first projecting portion, and the projecting portion matching the second clamping groove is denoted as a second projecting portion. The width of the first clamping groove is greater than the width of the second clamping groove, and the width of the first projecting portion is correspondingly greater than the width of the second projecting portion.

It should be clarified that the “first” clamping groove and the “second” clamping groove merely aim to differentiate the two grooves 22, and the “first” projecting portion and the “second” projecting portion also merely aim to differentiate the two projecting portions, and thus shall not be construed as limiting to the number and sequence of these components.

One form of the base 20 is described above, and of course, besides this, the base 20 may also be in a flat plate shape. The flat plate shape may be square.

An outer edge of the base 20 may further be provided with a groove 22. There grooves 22 might be in number of more than one, and these grooves may be located on both parallel sides of the base 20.

As to details not mentioned above, the prior art may be applied.

Although terms indicating structures, such as “base”, “receiving cavity”, “upper cover”, “magnetic core coil”, are adopted multiple times above, it does not exclude possibilities of using other terms. The use of these terms merely aims to more conveniently describe and explain the essence of the present application; and it is against the spirit of the present application if the terms are construed as any additional limitation.

The above mentioned are merely specific embodiments of the present application; however, the scope of protection of the present application is not limited thereto. Any variations or substitutions, obtained by the technician familiar with the technical field based on the technical scope disclosed in the present application, shall be covered in the scope of protection of the present application. Thus, the scope of protection of the present application shall be defined according to the scope claimed by the claims.

1. A network transformer, comprising a base and an upper cover, wherein the base and the upper cover are engaged with each other to form a receiving cavity, and the receiving cavity is provided therein with at least one magnetic core coil.

2. The network transformer according to claim 1, wherein the at least one magnetic core coil is welded on the base.

3. The network transformer according to claim 1, wherein the at least one magnetic core coil is two magnetic core coils.

4. The network transformer according to claim 1, wherein the base is provided with a locating hole, the upper cover is provided with a locating column, and the locating column is inserted into the locating hole so that the upper cover is covered on the base.

5. The network transformer according to claim 4, wherein the locating column is in number of at least three.

6. The network transformer according to claim 4, wherein the locating hole is in number of at least three.

7. The network transformer according to claim 1, wherein the base is provided with at least one mounting groove for respectively mounting the at least one magnetic core coil.

8. The network transformer according to claim 7, wherein the at least one mounting groove is two mounting grooves.

9. The network transformer according to claim 1, wherein the base is in a shape of a flat plate.

10. The network transformer according to claim 1, wherein an outer edge of the base is provided with a groove.

11. The network transformer according to claim 2, wherein copper wires of the at least one magnetic core coil are directly welded with a pad of the base.

12. The network transformer according to claim 2, wherein copper wires of the at least one magnetic core coil are welded, by using tin, with a pad of the base.

13. The network transformer according to claim 2, wherein no covering is provided on a welding point with the welding point used for welding.

14. The network transformer according to claim 2, wherein a covering is provided on a welding point with the welding point used for welding.

15. The network transformer according to claim 2, wherein the at least one magnetic core coil is two magnetic core coils.

16. The network transformer according to claim 2, wherein the base is provided with a locating hole, the upper cover is provided with a locating column, and the locating column is inserted into the locating hole so that the upper cover is covered on the base.

17. The network transformer according to claim 3, wherein the base is provided with a locating hole, the upper cover is provided with a locating column, and the locating column is inserted into the locating hole so that the upper cover is covered on the base.
